(19) United States
(12) Patent Application Publication
(10) Pub. No.: US 2020/0317032 A1
(43) Pub. Date: Oct. 8, 2020

(54) HEAT EXCHANGER

(71) Applicant: Valeo North America, Inc., Auburn Hills, MI (US)

(72) Inventors: Don Cropp, Auburn Hills, MI (US); Kerry Machesney, Auburn Hills, MI (US)

(73) Assignee: Valeo North America, Inc., Auburn Hills, MI (US)

(21) Appl. No.: 16/373,166

(22) Filed: Apr. 2, 2019

(51) Int. Cl. B60H 3/02

(52) U.S. Cl. CPC B60H 3/024; B60H 2003/026; B60H 2003/028

(57) ABSTRACT

A bottle for a heat exchanger extending in a longitudinal direction, including a tubular main body comprising a first opening, a plug having a plug body inserted at least partially into the tubular body to close the first opening, a retaining element adapted to retain the plug with respect to the tubular main body after insertion of the retaining element into the tubular main body, wherein the plug comprises a guiding means adapted to guide the retaining element during insertion of the retaining element and the retaining element is configured to be locked in the tubular body, the retaining element and the plug cooperating together to retain the plug in the tubular main body along the longitudinal axis.

### FIELD OF THE INVENTION

The invention relates to a heat exchanger, in particular to a heat exchanger for a motor vehicle.

### BACKGROUND OF THE INVENTION

The present invention relates to a container in a form of a bottle for a vehicle air conditioner, and more particularly, to a removable plug for such bottle. Containers for refrigeration systems include, inter alia, a replaceable cartridge filled with desiccating granules. This cartridge is introduced into a tubular element defining an opening of the container to the outside. This opening can be closed by a plug provided with O-rings and which can be introduced by sliding into the tubular element. Inward displacement of the plug is limited by a stop means in the form of a circular collar on the internal surface of the tubular element.

The plug can be threaded on its outer portions to prevent it from sliding out of the bottle when the pressure increases. In this case, the inner side of the bottle must also be threaded to enable the assembling process. However, using threads is disadvantageous, due to problems with proper plug alignment with respect to the bottle and sealing thereof. Moreover, vibrations and temperature variations can loosen the threaded connection and make the plug disassemble form the bottle. Further, if the plug and the bottle are made of different materials, then the plug may not provide a proper sealing along the thread, due to different thermal expansion properties of two different materials.

To prevent the plug from coming out when the pressure in the container increases on operation of the plant, other detachable axial stop means can be introduced in order to limit the outward movement of the plug. Supporting the plug is known, however the threaded plug and/or supporting means are not efficient and can cause variable service problems.

For obvious reasons of safety, it is desirable for it to be impossible to remove the detachable axial stop means while an over-pressure exists inside the container. In other words, the operator must wait until the pressure inside the container has fallen practically to atmospheric pressure to be able to remove the plug to then have access to the inside of the tubular element in order, for example, to change the cartridge with desiccating granules. The threaded connection between the plug and the bottle exhibits another problem related to sealing the bottle, i.e. the sealing can suffer from inconsistent O-ring compression when concentricity of threads used to locate the plugs are not meeting the required tolerances.

With respect to reasons stated above, in is desirable to eliminate the need for threaded plug, and allow for self-locating of O-rings for consistent compression, while also withstanding the high service pressure in the bottle.

### SUMMARY OF THE INVENTION

The present invention relates to a bottle for a heat exchanger. The bottle extends in a longitudinal direction. The bottle comprises, inter alia, a tubular main body comprising a first opening, a plug having a plug body inserted at least partially into the tubular body to close the first opening, a retaining element adapted to retain the plug with respect to the tubular main body after insertion of the retaining element into the tubular main body.

The plug comprises a guiding means adapted to guide the retaining element during insertion of the retaining element and the retaining element is configured to be locked in the tubular body, the retaining element and the plug cooperating together to retain the plug in the tubular main body along the longitudinal axis.

The object on an invention provides a serviceable closure for a receiver drier installed in a motor vehicle air conditioning loop. High pressure of a refrigerant can cause irreversible damage, thus to put the invention into advantage, the play between the plug and the main body is allowable to a certain extent. This enables a proper sealing and minimizes the possibility of leakage in the plug area, due to high adaptiveness of a plug to a changing physical environment. From the service point of view, installing or re-installing the plug onto the main body is facilitated thanks to guiding elements providing quick and reliable assembly. When assembled, the plug is immobilized in a longitudinal direction of the tube in both directions. This prevents either leakage or disassembling the plug from the main body or, while re-installing a plug, pushing it too far inside the main body.

Preferably, the tubular main body comprises a refrigerant inlet, through which a refrigerant is introduced into the main body and a refrigerant outlet, through which a liquid refrigerant flows out of the main body.

Preferably, the refrigerant inlet and the refrigerant outlet are disposed at the same end of the main tubular body as the first opening.

Preferably, the tubular main body comprises at least two retaining openings for receiving the retaining element.

Preferably, the axis of retaining openings are aligned perpendicularly in reference to the longitudinal direction of the main body.

Preferably, the axis of retaining openings are aligned at an angle in reference to the longitudinal direction of the main body.

Preferably, the retaining openings have at least one rounded cross section.

Preferably, retaining openings have at least one rectangular cross section.

Preferably, a drying agent is inserted into the main body to trap the moisture inside the bottle.

Preferably, a filter is inserted into the main body to trap the particulate matter inside the bottle.

Preferably, the tubular main body comprises a second opening disposed at an opposite end of the tubular main body to the first opening.

Preferably, the tubular main body comprises only one opening.

Preferably, a second opening is closed by a sealing cup which is undetachably connected with the second opening of the body and provides a sealing thereof.

Preferably, the tubular main body and the sealing cup are made of lightweight metal alloy, e.g. aluminum.

Preferably, the plug body has essentially cylindrical shape.

Preferably, the plug body has a diameter (D) and a height (H), wherein the height is perpendicular to the radius (r) and parallel to the longitudinal direction of the tubular main body.

Preferably, the height of the plug defines the longitudinal direction of the plug.

Preferably, the plug body comprises an outer portion, a middle portion and an inner portion, wherein the inner portion has smaller cross section than the middle portion and the outer portion has the largest cross section.

Preferably, the plug body has a cross sections of variable dimensions in the planes parallel to the radius (r) of the plug body.

Preferably, the guiding means is in a form of a groove extending along the outer perimeter of the plug body, configured to receive the retaining element, so that the retaining means is placed along its length between the plug and the tubular main body.

Preferably, the guiding means is in a form of an opening extending through the plug body in the direction transverse to the height of the plug.

Preferably, the plug body comprises an inspection opening, disposed on the outer surface of the middle portion of the plug body, for simplifying insertion of the retaining element through the guiding means.

Preferably, the plug body comprises a collar, disposed on the outer portion of the plug body, for providing proper transverse alignment of the guiding means of the plug with retaining openings of the tubular main body.

Preferably, the plug body comprises an inner portion, disposed on the inner portion of the plug body, for introducing a filter into the bottle.

Preferably, the plug body comprises one or a plurality of sealing receivers distanced from each other along the longitudinal direction of the plug which are integrally formed by surrounding the peripheral surface of the middle portion of the plug body.

Preferably, the plug body is made of a synthetic material.

Preferably, the retaining element is a cylindrical bar comprising at least two different cross sections along its longitudinal direction, wherein the cross section of bigger dimensions is a head and the cross section of smaller dimensions is a shaft.

Preferably, the retaining element comprises a spring portion on the far end of smaller cross section, configured to immobilize the retaining element in a transverse direction.

Preferably, the retaining element comprises a threaded end, wherein the thread of retaining element is coupled with the thread of the tubular main body.

Preferably, the head is pushed by force into the retaining openings, wherein the diameter of the head is approximate to the diameter of the retaining opening.

Preferably, the retaining element is a springy resilient clip inserted through the plug body, comprising at least two adjacent arms.

Preferably, a springy resilient clip arms are essentially V-shaped.

Preferably, the retaining element comprises a crosswise portion at the confluence of clip arms, configured to hook against the plug body.

Preferably, the retaining element comprises a spearhead tips at the ends of the clip arms, configured to anchor the retaining element to the tubular main body.

Preferably, the retaining element is made of a metallic compound or a synthetic material.

Preferably, the plug comprises one or a plurality of an O-rings which are integrally formed by surrounding the peripheral surface of the plug body and they are spaced apart from each other by a predetermined gap.

Preferably, the tubular main body is sealed by the means of gluing the plug body to the tubular main body.

### BRIEF DESCRIPTION OF DRAWINGS

Examples of the invention will be apparent from and described in detail with reference to the accompanying drawings, in which:

FIG. 1 shows an exploded perspective view of elements forming a bottle.

FIG. 2 shows the first longitudinal section view of a plug assembly according one of the embodiments of an invention.

FIG. 3 shows the second longitudinal section view of a plug assembly according to one of the embodiments of an invention.

FIG. 4 shows a perspective view of a plug body retained by blocking element.

FIG. 5 shows the cross-sectional view of a plug assembly according one of the embodiments of an invention.

### DETAILED DESCRIPTION OF EMBODIMENTS

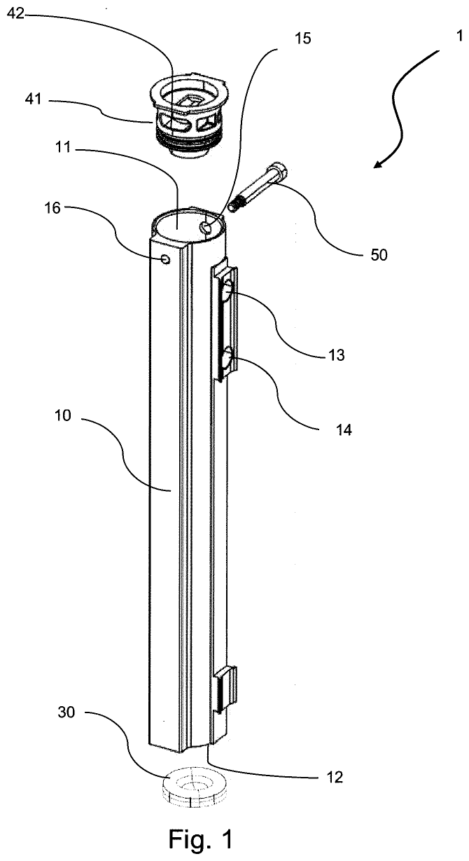

The subject of an invention is a bottle 1 for a heat exchanger, in particular for a condenser installed in a motor vehicle air conditioning system. The main elements constituting the bottle 1 are presented in the FIG. 1. The bottle 1 extends in a longitudinal direction. In the preferred embodiment of an invention, the bottle 1 comprises, among others, a tubular main body 10 comprising at least one opening 11,12, a plug 40 having a plug body 41 inserted into a first opening 11 for closing it and a retaining element 50 adapted to retain the plug 40 with respect to the tubular main body 10 after insertion of the retaining element 50 into the tubular main body 10.

The plug 40 comprises a guiding means 42 adapted to guide the retaining element 50, so that the plug 40 is immobilized in a longitudinal direction with respect to the tubular main body 10.

The tubular main body 10 comprises a refrigerant inlet 13, through which a refrigerant is introduced into the main body 10 and a refrigerant outlet 14, through which a liquid refrigerant flows out of the main body 10.

In the basic embodiment of an invention, the refrigerant inlet 13 and the refrigerant outlet 14 are disposed at the same end of the main tubular body 10 as the first opening 11. In other embodiments of an invention, the refrigerant inlet 13 and the refrigerant outlet 14 are disposed at the same end of the main tubular body 10 as the second opening 12.

The tubular main body 10 comprises at least two retaining openings 15, 16 for receiving a retaining element 50. The amount of retaining openings 15,16 depends on the type of used retaining element 50. In a preferred embodiment of an invention, the axis of retaining openings 15, 16 are aligned perpendicularly in reference to the longitudinal direction of the tubular main body 10, whereas the longitudinal direction of the tubular main body 10 is defined by the first and the second openings 11,12.

In another embodiment of an invention, the axis of retaining openings 15, 16 are aligned at an angle in reference to the longitudinal direction of the tubular main body 10. This enables retaining the plug 40 when the space outside of the bottle is limited due to packaging, so if the retaining openings 15, 16 were aligned perpendicularly in reference to the longitudinal direction of the tubular main body 10, entering the retaining portion 50 would be impossible.

In another embodiment of an invention, the tubular main body 10 comprises at least one retaining opening 15,16 of a rounded cross section. Rounded refers to all types of openings which have an essentially rounded cross section, including circular, oval, oblong, etc. The shape and configuration of the retaining openings 15,16 depends mainly on predetermined design.

The retaining openings 15,16 are preferably in a form of a through hole, however in some particular embodiments a form of blind hole is also executable, e.g. the threaded, blind retaining opening 16 is configured to receive threaded retaining element 50.

Alternatively, the retaining openings 15, 16 have at least one rectangular cross section.

For proper work of the bottle 1 configured as receiver drier, a drying agent is inserted into the tubular main body 10 to trap the moisture inside the bottle 1. Moisture capture increases overall efficiency of the whole air conditioning loop. Moreover, it reduces the risk of malfunction caused by the corrosion of loop elements.

For proper work of the bottle 1 configured as receiver drier, a filter is inserted into the main body 10 to trap the particulate matter inside the bottle 1. Particulate matter can cause an irreversible damage in the air conditioning loop, especially to a compressor and an expansion valve. Inserting the filter into the bottle 1 traps the particulate matter inside the tubular main body 10. The filter is attached to the inner portion 47 of a plug body 41.

In one or more embodiments, the tubular main body 10 comprises only one opening 11. The opening 11 is adapted to receive the plug 40 into the tubular main body 10. The second opening 12 is consolidated on the opposite end of the tubular main body 10, i.e. the material for closing the second opening 12 comes from the tubular main body 10.

Alternatively, the second opening 12 remains opened. The tubular main body 10 with the second opening 12 is easier to manufacture than the one described in the previous embodiment, yet in needs a proper means of sealing. The second opening 12 must be closed by e.g. a sealing cup 30 which is undetachably connected (e.g. brazed) with the second opening 12 of the tubular main body 10 to provide a sealing thereof. Undetachable connection comprises also any means of providing a rigid connection between of the sealing cup 30 and the tubular main body 10, which will sustain the pressure without a leakage from the bottle 1.

The tubular main body 10 and the sealing cup 30 are made of lightweight metal alloy (e.g. aluminum). The plug body 41 is preferably made of the synthetic material that will sustain a temperature and pressure variations.

According to the main embodiment of an invention, the plug body 41 has essentially cylindrical shape. The plug body 41 has a diameter D and a height H. The diameter D is two times bigger than the radius r. The height H is perpendicular to the radius r and parallel to the longitudinal direction of the tubular main body 10. The height H defines the longitudinal direction of the plug 40. According to the another embodiment of an invention, the plug body 41 has a cross sections of variable dimensions in the planes parallel to the radius r of the plug body 41.

The plug body 41 can be easily divided into an outer portion 49, a middle portion 48 and an inner portion 47. The inner portion 47 has smaller cross section than the middle portion 48. The outer portion 49 has the largest cross section. The inner portion 47 is configured to hold a filter in the vicinity of the retaining openings 15,16. Unlike the outer portion 49 and the middle portion 48, the inner portion 47 is not in a direct contact with the tubular main body 10. The middle portion 48 is configured to guide the plug 40 along the longitudinal direction of the tubular main body 10. The middle portion 48 does not come into contact with the tubular main body 10 with its entire surface, i.e. the insertion of the plug 40 into the tubular main body 10 does not require using force. A small play between these two elements is preferred, so that the alignment of the plug 40 inside the tubular main body 10 is facilitated. This feature enables adapting of the plug body 41 to the inner walls of tubular main body 10 accordingly to the pressure inside the bottle 1.

In one or more embodiments, the plug 40 comprises at least one guiding means 42 located in the middle portion 48 of the plug body 41. In this embodiment, the guiding means 42 is fundamentally a through hole augmented in a transversal direction of the plug main body 41, so that the retaining element 50 enables slight rotation of the plug body 41 inside the tubular main body 10. In the other embodiment, the guiding means 42 forms a groove extending along the outer perimeter of the plug body 41. To enable proper immobility of the plug 40 in reference to the tubular main body 10, the retaining openings 15, 16 have to be moved to the side of the tubular main body 10. The retaining openings 15, 16 are disposed to correspond the curvature of the retaining portion 42 groove on the plug body 41.

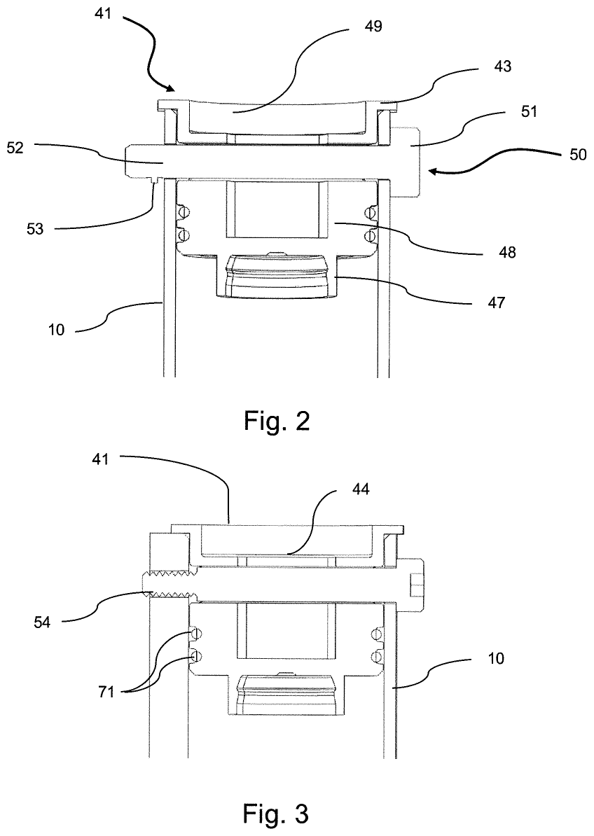

According to FIG. 2, the plug body 41 comprises a collar 43, disposed on the outer portion 49 of the plug body 41. The collar 43 provides a proper lateral alignment of the guiding means 42 of the plug 40 with the retaining openings 15, 16 of the tubular main body 10. However, the invention is executable without using the collar 43.

According to the FIG. 3, the plug body 41 comprises an inspection opening 44, disposed on the outer surface of the middle portion 48. The inspection opening 44 is adapted to simplify insertion of the retaining element 50 through the guiding means 42.

The object of the invention comprises a retaining element 50 which in the basic embodiment is a cylindrical bar comprising at least two different portions, wherein the portion of bigger cross section is a head 51 and the portion of smaller cross section is a shaft 52. The retaining element 50 can be made of a metallic compound or a synthetic material. FIGS. 1-5 present exemplary embodiments of a retaining elements.

In one of the embodiments, the retaining element 50 comprises a spring portion 53 on the far end of the smaller cross section portion, as presented in the FIG. 2. The spring portion 53 is configured to immobilize the retaining element 50 in a transverse direction. The retaining element 50 is entered through the retaining opening 15, the spring portion 53 shall be compressed into the shaft 52. Further, the retaining element 50 is entered through the guiding means 42 and the retaining opening 16 with compressed spring portion 53.

Next, the spring portion needs to decompress while it exits the outer side of the opening 16. Since then, the retaining element 50 is immobilized in a transversal direction by a head 51 from the one side of a plug body 41 and by the spring portion 53 from the other side of the plug body 41.

In one of the embodiments, the shaft 52 comprises a threaded section 54, wherein the thread is located on the far end of the smaller cross section portion of the retaining portion 50, as shown in the FIG. 3. Alternatively, the whole portion comprising a smaller cross section is threaded. The threaded section 54 of retaining element 50 is coupled with the corresponding thread of the tubular main body 10. In other embodiment of an invention, the threaded section 54 of retaining element 50 is located on the portion of a bigger cross section and it is coupled with the corresponding thread of the tubular main body 10.

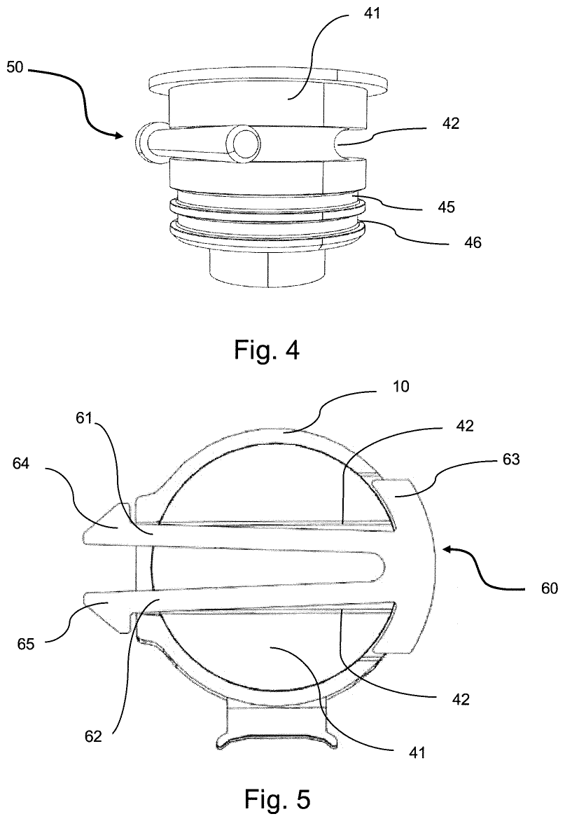

In one of the embodiments, the retaining element 50 comprises the head 51 which is pushed by force into the corresponding retaining openings 15,16, wherein the diameter of the head 51 is approximate to the diameter of the corresponding retaining opening 15,16, so that the friction between the retaining element 50 and the retaining opening 15,16 is sufficient to immobilize the retaining element 50. The head 51 remains trapped after insertion into the opening. The process is reversible either by pulling the protruding portions of the head, or by hitting the portion of the shaft 52 in an opposite direction. The retaining element 50 suitable for this method of assembly is presented in the FIG. 4.

According to invention presented in FIG. 4, the plug body 41 comprises one or a plurality of sealing receivers 45, 46 distanced from each other along the longitudinal direction of the plug 40 which are integrally formed by surrounding the peripheral surface of the middle portion 48 of the plug body 41.

In one of the embodiments, the retaining element 50 is a springy resilient clip 60, as presented in the FIG. 5. The clip comprises at least two adjacent arms 61,62 with spearhead tips 64, 65. The length of respective arms is comparable to the distance between the first and the second retaining openings 15, 16. The arms of the clip comprise a crosswise portion 63 which is located at the confluence of clip arms 61, 62. The adjacent arms 61, 62 are compressed (e.g. by the operator) to enable entering the springy resilient clip 60 into the plug body 41. As soon as the adjacent arms 61, 62 penetrate the retaining opening 15, the guiding means 42, and the second opening 16, the adjacent arms 61, 62 release tension and the springy resilient clip 60 remains trapped. The tension between adjacent arms 61 and 62 is created by essentially V-shaped form of the springy resilient clip 60. The V-shape defines portion, wherein two adjacent side faces creating a V-form are symmetrical, yet the angle between them is less than 90 degrees. V-shape expression does not indicate whether the form of a peak is rounded or sharp, as long as the side faces fulfill previously mentioned requirement. The spearhead tips 64, 65 anchor the retaining element 50 and the crosswise portion 63 is leaning against the plug body 41 preventing the springy resilient clip 60 from sliding through the plug body 41.

The plug 40 is configured to receive sealing means, in particular an O-rings 71, which are integrally formed by surrounding the peripheral surface of the plug body 41 and they are spaced apart from each other by a predetermined gaps. Alternatively, the tubular main body 10 is sealed by the means of gluing the plug body 41 to the tubular main body 10.

Other variations to the disclosed embodiments can be understood and effected by those skilled in the art in practicing the claimed invention, from a study of drawings, the disclosure, and the appended claims. The mere fact that certain measures are recited in mutually different dependent claims does not indicate that a combination of these measures cannot be used to the advantage.

1. A bottle for a heat exchanger, the bottle extending in a longitudinal direction, comprising:
a tubular main body comprising a first opening;
a plug having a plug body inserted at least partially into the tubular main body to close the first opening; and
a retaining element adapted to retain the plug with respect to the tubular main body after insertion of the retaining element into the tubular main body,
wherein the plug comprises a guiding means adapted to guide the retaining element during insertion of the retaining element and the retaining element is configured to be locked in the tubular main body, the retaining element and the plug cooperating together to retain the plug in the tubular main body along the longitudinal axis.

2. The bottle according to claim 1, wherein the tubular main body comprises at least two retaining openings for receiving the retaining element.

3. The bottle according to claim 1, wherein the plug body has essentially cylindrical shape.

4. The bottle according to claim 1, wherein the plug body comprises an outer portion, a middle portion and an inner portion, wherein the inner portion has smaller cross section than the middle portion and the outer portion has the largest cross section.

5. The bottle according to claim 4, wherein the plug body has a cross sections of variable dimensions in the planes parallel to the radius of the plug body.

6. The bottle according to claim 5, wherein the guiding means is in a form of a groove extending along the outer perimeter of the plug body, configured to receive the retaining element, so that the retaining means is placed along its length between the plug and the tubular body.

7. The bottle according to claim 1, wherein the guiding means is in a form of opening extending through the plug body in the direction transverse to the height of the plug.

8. The bottle according to claim 4, wherein the plug body comprises an inspection opening, disposed on the outer surface of the middle portion of the plug body, for simplifying insertion of the retaining element through the guiding means.

9. The bottle according to claim 1, wherein the retaining element is a cylindrical bar comprising at least two different cross sections along its longitudinal direction, wherein the cross section of bigger dimensions is a head and the cross section of smaller dimensions is a shaft.

10. The bottle of claim 9, comprising a spring portion on the far end of smaller cross section, configured to immobilize the retaining element in a transverse direction.

11. The bottle of claim 9, comprising a threaded end, wherein the thread of retaining element is coupled with the thread of the tubular main body.

12. The bottle according to claim 1, wherein the retaining element is a springy resilient clip inserted through the plug body, comprising at least two adjacent arms.

13. The bottle of a claim 12, comprising a crosswise portion at the confluence of clip arms, configured to hook against the plug body.

14. The bottle of claim 12, further comprising a spearhead tips at ends of the clip arms, configured to anchor the retaining element to the tubular main body.

15. A heat exchanger for a motor vehicle comprising:
a bottle extending in a longitudinal direction and comprising:
a tubular main body comprising a first opening;
a plug having a plug body inserted at least partially into the tubular main body to close the first opening; and
a retaining element adapted to retain the plug with respect to the tubular main body after insertion of the retaining element into the tubular main body,
wherein the plug comprises a guiding means adapted to guide the retaining element during insertion of the retaining element and the retaining element is configured to be locked in the tubular main body, the retaining element and the plug cooperating together to retain the plug in the tubular main body along the longitudinal axis.
